(19) United States
(12) Patent Application Publication
(10) Pub. No.: US 2021/0048850 A1
(43) Pub. Date: Feb. 18, 2021

(54) FIRMWARE SETUP MENU OPTIONS FOR DOCKING STATIONS

(71) Applicant: Hewlett-Packard Development Company, L.P., Spring, TX (US)

(72) Inventors: Yi-Fan Hsia, Taipei City (TW); Pifang Lai, Taipei City (TW); Hung Lung Chen, Taipei City (TW)

(73) Assignee: Hewlett-Packard Development Company, L.P., Spring, TX (US)

(21) Appl. No.: 16/976,491

(22) PCT Filed: Apr. 17, 2018
(86) PCT No.: PCT/US2018/027844

§ 371 Date: Aug. 28, 2020

(51) Int. Cl. G06F 1/16; G06F 8/65; G06F 13/42

(52) U.S. Cl. CPC G06F 1/1632; G06F 2213/0042; G06F 13/4282; G06F 8/65

(57) ABSTRACT

In one example, an apparatus is described, which may include a port to couple a docking station to the apparatus and an embedded controller. The embedded controller may receive a connection status of the docking station. Further, the embedded controller may provide a docking option corresponding to the docking station in a firmware setup menu based on the connection status. Furthermore, the embedded controller may receive a user input to control a peripheral device on the docking station via the docking option in the firmware setup menu. Then, the embedded controller may generate a command corresponding to the user input to control the peripheral device on the docking station.

### BACKGROUND

Docking stations, also referred to as port replicators, have various ports for connecting to different peripheral devices such as a keyboard, mouse. audio/video output, storage device, or the like. Each port may have a separate function (e.g., audio, video, power, and the like). When a computing device is docked with the docking station, the ports can be provided as if the peripheral devices were the part of the computing device. Thus, the computing device can be allowed to connect with various peripheral devices than would be possible using the ports on the computing device.

### BRIEF DESCRIPTION OF THE DRAWINGS

Examples are described in the following detailed description and in reference to the drawings, in which:

FIG. 1 is a block diagram of an example apparatus, including an embedded controller to provide a docking option in a firmware setup menu for controlling a peripheral device on a docking station;

FIG. 2 is a block diagram of an example computing device to provide a docking option corresponding to a docking station in a firmware setup menu based on a device identifier;

FIG. 3 is a block diagram of the example computing device and the docking station of FIG. 2, depicting additional features;

FIG. 4 is an example flow diagram for enabling, disabling, or configuring a peripheral device on a docking station based on a connection status of the docking station;

FIG. 5A is an example sequence diagram for providing a docking option in a firmware setup menu of a computing device based on an authentication of a docking station;

FIG. 5B is an example sequence diagram for removing the docking option from the firmware setup menu upon detecting a disconnection event of the docking station;

FIG. 5C is on example sequence diagram for controlling a peripheral device on the docking station based on a user input received via the firmware setup menu;

FIG. 6A is a block diagram of an example computing device including a non-transitory machine-readable storage medium, storing instructions to provide a docking option in a firmware setup menu based on an authentication of a docking station; and

FIG. 6B is a block diagram of the example computing device of FIG. 6A, storing further instructions to enable, disable, or configure a peripheral device on the docking station based on a user input received via the firmware setup menu.

### DETAILED DESCRIPTION

When a computing system or computing device is powered on, the computing device may undergo an initial set of operations to configure the hardware and programming of the computing device. This process may refer to as a boot process. The boot process may be performed using a firmware such as a basic input/output system (BIOS), unified extensible firmware interface (UEFI), or the like. The firmware may be implemented in hardware, machine-readable instructions, or a combination thereof. The firmware may be stored on a chip (e.g., embedded controller) located on a motherboard of the computing device. The firmware may refer to a boot program that can be executed as instructions when the computing device is first powered on along with a set of configurations specified for the firmware. The firmware and associated configurations may be stored in a non-volatile memory such as a non-volatile random-access memory (NVRAM) or a read-only memory (ROM), The firmware may recognize, initialize, and test hardware present in the computing device based on the set of configurations.

After the power button is activated, the computing device may first load in the firmware to perform tasks such as performing power-on self-test (POST), detecting hardware, installing drivers, and loading in an operating system (OS), The firmware then gives control of the computing device to the OS. The firmware may provide an interface to allow a variety of different parameters to be set. For example, the firmware can be used to specify what peripheral devices are attached to the computing device. Many computing devices may have ports to connect to and interface with the peripheral devices. Such ports may implement the universal serial bus (USB) standard. The physical interface specifications of the USB standard may allow for a variety of peripheral devices to be connected to the computing device using a simple and standardized socket. Example peripheral devices may include external hard drives, mice, keyboards, wireless network adapters, scanners, printers, and the like. Further, USB ports may be managed by a host controller (e.g., a hardware device that serves as an interface between a computing device and the peripheral devices connected to the USB ports of the computing device). In addition to managing the flow of data between the host computing device and the peripheral devices, the host controller may also provide an electrical power from the computing devices power supply to the peripheral devices via the USB ports. The firmware may include a firmware setup menu to control the peripheral devices on the computing device.

However, the peripheral devices can also be connected, to the computing devices via docking stations. Docking stations may provide the computing devices with a “one stop” quick connection to the peripheral devices that are included in the docking stations. Docking station may be connected to the computing device, for instance, by a USB interface, Further, various peripheral ports, such as a display port, USB-C port, USB-A port, video graphics array (VGA) port, network interface card (NIC), earphone, and audio module (e.g., a microphone, volume up/down, hang off, and call), may be provided on the docking station. However, the firmware setup menu may not support the peripheral devices and features on a docking station that is connected to the computing device via the USB interface such as a USB type-C connector. Hence, the peripheral devices on the docking station may not be controlled via the firmware setup menu.

Examples described herein may provide docking options corresponding to docking stations in a firmware setup menu and facilitate to enable, disable, or configure peripheral devices on the docking station via the firmware setup menu. Examples described herein may not impact the boot time to perform the hardware detection as the docking station detection can be done during plug-in and plug-out of the docking station, and not during power-on self-test (POST), In this case, a device identifier of the docking station may be updated when the docking station is plugged-in or plugged-out, and not during the POST, The docking options may be provided in the firmware setup menu based on the device identifier. Thus, examples described herein may not impact boot time to detect the docking station.

Examples described herein may utilize vendor defined messages (VDMs), a standard in power delivery protocol, to implement the docking station detection and peripheral device control on the docking station. Examples described herein can be implemented in computing devices without involving any additional hardware component. The firmware may enable, disable, or configure the peripheral devices on the docking station via the vendor defined messages.

In the following description, for purposes of explanation, numerous specific details are set forth in order to provide a thorough understanding of the present techniques. It will be apparent, however, to one skilled in the art that the present apparatus, devices and systems may be practiced without these specific details. Reference in the specification to “an example” or similar language means that a particular feature, structure, or characteristic described is included in at least that one example, but not necessarily in other examples.

Examples described herein may provide an apparatus having a port (e.g., a USB type-C connector) to couple a docking station to the apparatus. Further, the apparatus may include an embedded controller to receive a connection status of the docking station, provide a docking option corresponding to the docking station in a firmware setup menu based on the connection status, receive a user input to control a peripheral device on the docking station via the docking option in the firmware setup menu, and generate a command corresponding to the user input to control the peripheral device on the docking station.

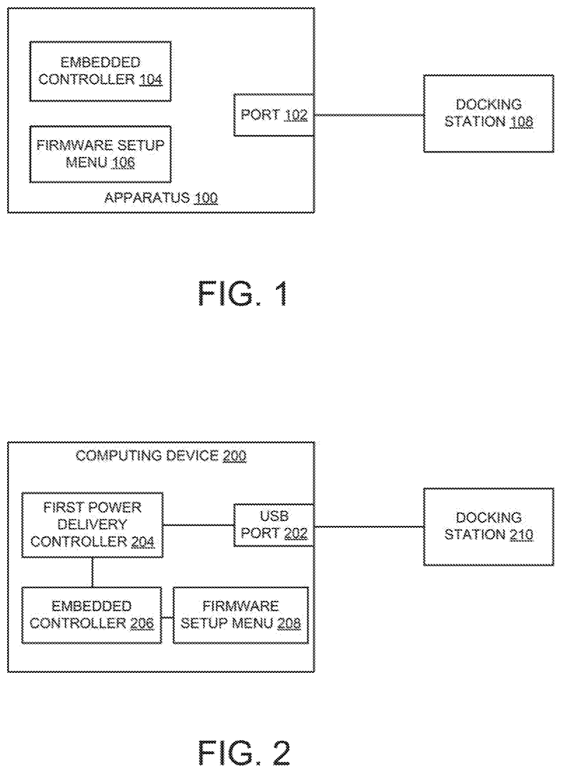

Turning now to the figures, FIG. 1 is a block diagram of an example apparatus 100, including an embedded controller 104 to provide a docking option in a firmware setup menu 106 for controlling a peripheral device on a docking station 108. Example apparatus 100 may include a notebook, tablet, personal computer (PC), smart phone, gaming laptop, workstation or the like.

Apparatus 100 may include a port 102 to couple docking station 108 to apparatus 100. Example port 102 may be a universal serial bus (USB) type-C port. Example docking station 108 may be provided with various peripheral ports such as a display port, USB-C port, USB-A port, video graphics array (VGA) port, network interface card (NIC), earphone, audio module (e.g., a microphone, volume up/down, hang off, and call), and/or the like. Docking station 108 may provide apparatus 100 with a connection to peripheral devices that are included in docking station 108 through the peripheral ports.

Further, apparatus 100 may include embedded controller 104. Embedded controller 104 may be implemented in hardware, machine-readable instructions, or a combination thereof. Embedded controller 104 may be implemented as engines or modules comprising any combination of hardware and programming to, implement the functionalities described herein. For example, embedded controller 104 can be implemented with a microcontroller, an application-specific integrated circuit (ASIC), a programmable gate array (PGA), or any other type of hardware component having access to firmware (e.g., BIOS, UEFI, or the like) stored in apparatus 100. In other examples, embedded controller 104 may include an internal data storage (e.g., random-access memory (RAM)), which can store the firmware.

Embedded controller 104 may receive a connection status of docking station 108. The connection status may indicate whether docking station 108 is plugged-in or plugged-out of apparatus 100. For example, USB type-C connector may implement a USB power delivery protocol. In some examples, embedded controller 104 may receive the connection status via a first power delivery controller (i.e., that conforms to the USB power delivery protocol) in apparatus 100. The first power delivery controller may communicate with a second power delivery controller in docking station 108 via a first vendor defined message to detect the connection status between port 102 and docking station 108. The first vendor defined message may conform to the USB power delivery protocol, The first power delivery controller is explained in FIG. 2.

Further, embedded controller 104 may provide a docking option corresponding to docking station 108 in a firmware setup menu 106 based on the connection status (i.e., when docking station 108 is plugged-in to apparatus 100). In some examples, embedded controller 104 may authenticate docking station 108 using a device identifier and provide the docking option in firmware setup menu 106 upon successful authentication.

In one example, embedded controller 104 may provide the docking option corresponding to docking station 108 in firmware setup menu 106 when docking station 108 is connected to port 102. In another example, embedded controller 104 may remove/not show the docking option corresponding to docking station 108 in firmware setup menu 106 when docking station 108 is disconnected from port 102.

Furthermore, embedded controller 104 may receive a user input to control a peripheral device on docking station 108 via the docking option in firmware setup menu 106. Also, embedded controller 104 may generate a command corresponding to the user input to control the peripheral device do docking station 108.

In one example, the first power delivery controller may receive the command corresponding to the user input from embedded controller 104 and communicate the command to the second power delivery controller via a second vendor defined message. The second vendor defined message may conform to the USB power delivery protocol. In some examples, the peripheral device on docking station 108 can be enabled, disabled, or configured based on executing the command by a microcontroller in docking station 108.

FIG. 2 is a block diagram of an example computing device 200 to provide a docking option corresponding to a docking station 210 in a firmware setup menu 288 based on a device identifier. Example computing device 280 may be a personal computer, a notebook computer, a tablet computer, a convertible device, a personal gaming device, and the like. Example convertible device may refer to a device that can be “convertible” from a laptop mode to a tablet mode.

Computing device 200 may include a USB port 202 such as a USB type-C connector. USB port 202 may implement a USB power delivery specification (e.g., the USB Type-C specification). For example, the USB Type-C connector can support USB communications and power delivery over USB power delivery protocols defined in various revisions of the USB power delivery specification.

Further, computing device 200 may include a first power delivery controller 204 and an embedded controller 206. First power delivery controller 204 and embedded controller 206 may be implemented in hardware, machine-readable instructions, or a combination thereof. First power delivery controller 204 and embedded controller 206 may be implemented as engines or modules comprising any combination of hardware and>programming to implement the functionalities described herein. Example first power delivery controller 204 may be a USB power delivery controller. First power delivery controller 204 may conform to the USB power delivery specification. For example, first power delivery controller 204 may communicate with docking station 210 via a vendor defined message that conforms to the USB power delivery specification.

During operation, first power delivery controller 204 may detect docking station 210 connected to USB port 202, for example, when the docking station 210 is plugged-in to computing device 200. Further, first power delivery controller 204 may communicate with docking station 210 to obtain a device identifier associated with docking station 210. In one example, first power delivery controller 204 may communicate with docking station 210 via a vendor defined message to obtain the device identifier. For example, first power delivery controller 204 may send a vendor defined message to docking station 210 and receive device identifier in a reply vendor defined message according to the USB power delivery specification, Further, first power delivery controller 204 may send the device identifier to embedded controller 206.

Embedded controller 206 may receive the device identifier associated with docking station 210 from first power delivery controller 204 and provide a docking option corresponding to docking station 210 in firmware setup menu 208 based on the device identifier. In one example, embedded controller 206 may authenticate docking station 210 using the device identifier and provide the docking option in the firmware setup menu 208 upon successful authentication.

Example firmware setup menu 208 may include a BIOS setup menu, UEFI setup menu, or the like. Upon booting computing device 200, a hot key can be pressed in a keyboard to allow the computing device 200 to enter firmware setup menu 208. In some examples, the docking option may control a peripheral device on docking station 210 via the firmware setup menu 208.

In other examples, first power delivery controller 204 may detect a disconnection event between docking station 210 and USB port 202 and communicate the disconnection event to embedded controller 206. In this example, embedded controller 206 may remove the docking option corresponding to docking station 210 from firmware setup menu 208 based on the disconnection event,

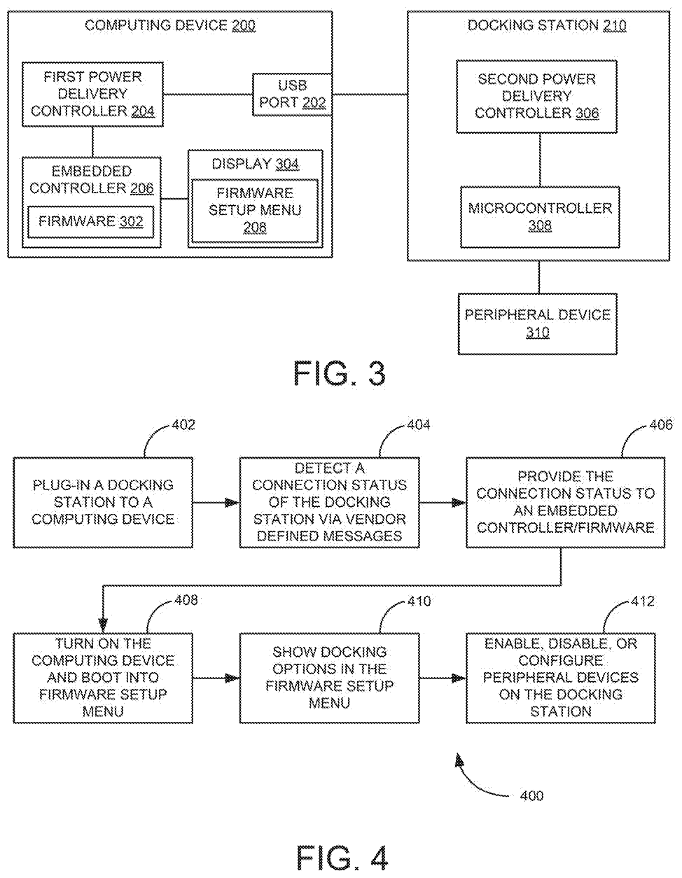

FIG. 3 is a block diagram of example computing device 200 and docking station 210 of FIG. 2, depicting additional features. For example, similarly named elements of FIG. 3 may be similar in structure and/or function to elements described with respect to FIG. 2. As shown in FIG. 3, computing device 200 may include firmware 302 (e.g., BIOS, UEFI, or the like) stored in embedded controller 206. In other examples, firmware 302 may be stored external to embedded controller 206 (e.g., in a non-volatile memory) and can be accessible to embedded controller 206. Further, computing device 200 may include display 304 to show firmware setup menu 208. Example display 304 may include liquid crystal display (LCD), light emitting diode (LED) display, electro-luminescent (EL) display, or the like.

Further as shown in FIG. 3, docking station 210 may include a second power delivery controller 306 and a microcontroller 308. Second power delivery controller 306 and microcontroller 308 may be implemented in hardware, machine-readable instructions, or a combination thereof. Second power delivery controller 306 and microcontroller 308 may be implemented as engines or modules comprising any combination of hardware and programming to implement the functionalities described herein.

During operation, first power delivery controller 204 may communicate with second power delivery controller 306 in docking station 210 via a vendor defined message to obtain the device identifier. Further, first power delivery controller 204 may send the device identifier to embedded controller 206. Embedded controller 206 may provide a docking option corresponding to docking station 210 in firmware setup menu 208 based on the device identifier. In some examples, the docking option may control a peripheral device 310 on docking station 210 via the firmware setup menu 208.

In one example, embedded controller 206 may receive, via firmware setup menu 208 on display 304, a user input to control peripheral device 310 on docking station 210. Further, embedded controller 206 may generate and send a command corresponding to the user input to first power delivery controller 204. Furthermore, first power delivery controller 204 may send the command to second power delivery controller 306 via a vendor defined message to control peripheral device 310 on docking station 210. For example, the command can be defined in a way to send information along with descriptors in vendor defined message packets using USB power delivery communications. In some examples, peripheral device 310 may be enabled, disabled, or configured by microcontroller 308 in docking station 210 based on the command.

Apparatus 100 of FIG. 1 or computing device 200 of FIGS. 2 and 3 may include computer-readable storage medium comprising (e.g., encoded with) instructions executable by a processor to implement functionalities described herein in relation to FIGS. 1-8. In some examples, the functionalities described herein, in relation to instructions to implement functions of components of apparatus 100 or computing device 200 and any additional instructions described herein in relation to the storage medium, may be implemented as engines or modules comprising any combination of hardware and programming to implement the functionalities of the modules or engines described herein, The functions of components of apparatus 100 or computing device 200 may also be implemented by a respective processor. In examples described herein, the processor may include, for example, one processor or multiple processors included in a single device or distributed across multiple devices.

FIG. 4 is an example flow diagram 400 for enabling, disabling, or configuring a peripheral device on a docking station based on a connection status of the docking station. At 402, a docking station (e, g., a USB type-C docking station) may be plugged-in to a computing device, for instance, by a user. At 404, a connection status of the docking station may be detected by a first power delivery controller in the computing device. In this example, the first power delivery controller may communicate with a second power delivery controller in the docking station via vendor defined messages to detect the connection status. At 406, the connection status may be provided to an embedded controller/firmware in the computing device by the first power delivery controller.

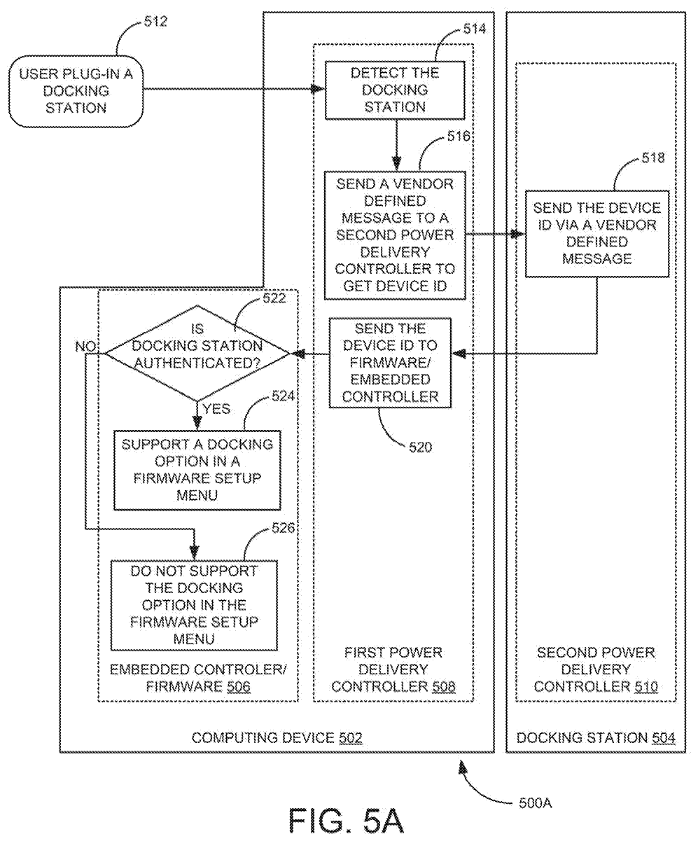

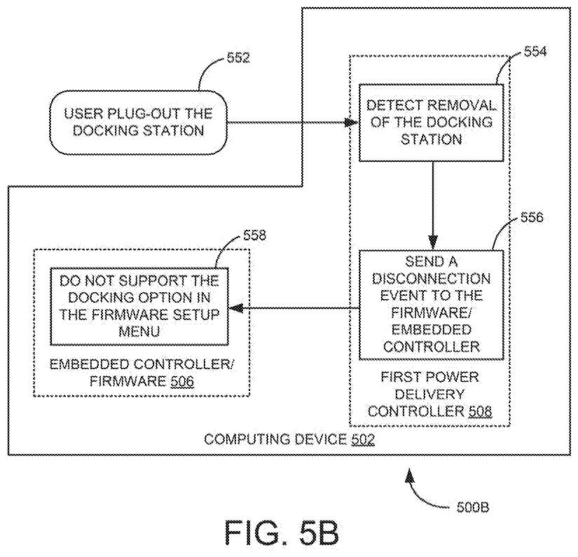

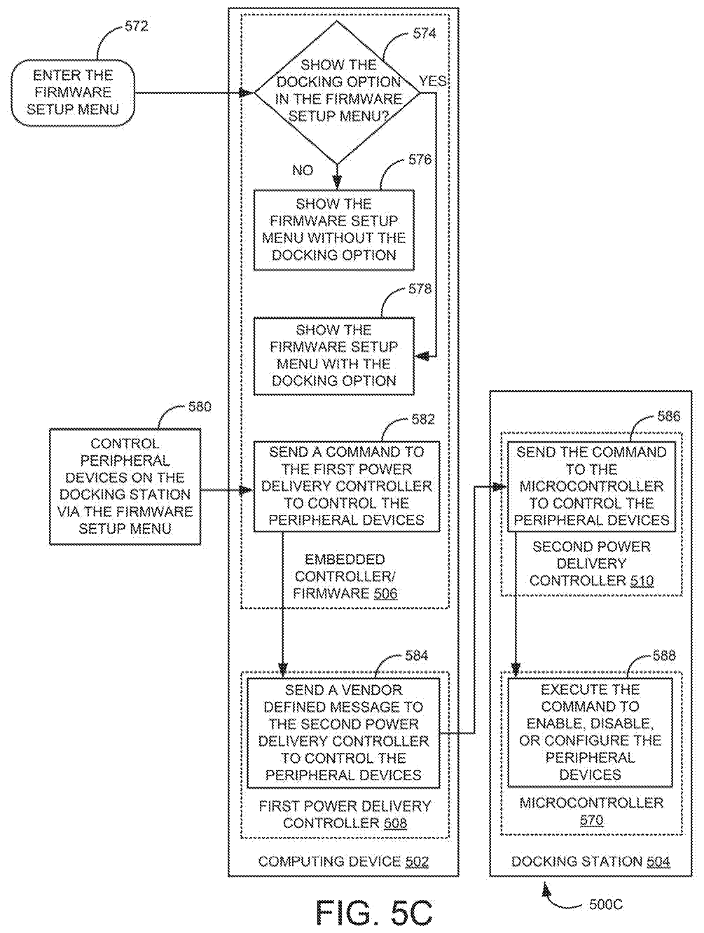

At 408, the computing device may be turned on and booted into a firmware setup menu. At 410, docking options may be showed in the firmware setup menu on a display of the computing device by the embedded controller/firmware. At 412, peripheral devices on the docking station may be enabled, disabled, or configured via the firmware setup menu. This is explained in detail in FIGS. 5A-5C.

FIG. 5A is an example sequence diagram 500A for providing a docking option in a firmware setup menu of a computing device 502 based on an authentication of a docking station 504. As shown in FIG. 5A, computing device 502 may include an embedded controller/firmware 506 and a first power delivery controller 508. Docking station 504 may include second power delivery controller 510. Example sequence diagram 500A may depict a sequence of flow between first power delivery controller 508 embedded controller/firmware 506, and second power delivery controller 510 to provide the docking option in the firmware setup menu.

At 512, docking station 504 (e.g., a USB type-C docking station) may be plugged-in to a USB port of computing device 502, for instance, by a user, At 514, docking station 504 (e.g., the USB type-C docking station) may be detected by first power delivery controller 508 upon plugged-in to computing device 502.

At 516, a vendor defined message may be sent to second power delivery controller 510 by first power delivery controller 508 to get device identifier (ID) associated with docking station 504 via the USB port. At 518, the device identifier may be sent to first power delivery controller 508 by second power delivery controller 510 via a reply vendor defined message. In this example, first power delivery controller 508 and second power delivery controller 510 may communicate with each other via vendor defined messages in accordance with a USB power delivery specification.

At 520, the device identifier may be sent to firmware/embedded controller 506 by first power delivery controller 508, For example, first power delivery controller 508 may communicate with firmware/embedded controller 506 via an I2C interface. At 522, firmware/embedded controller 506 may authenticate docking station 504 using the device identifier. In one example, firmware/embedded controller 506 may determine whether docking station 504 is associated with a specific vendor, such as Hewlett Packard. In this example, the firmware setup menu may support docking option when docking station 504 is associated with the specific vendor.

At 524, docking option may be supported in the firmware setup menu by firmware/embedded controller 506 when the authentication of docking station 504 is successful (e.g., when docking station 504 is associated with the specific vendor). In this example, the docking option may be displayed in the firmware setup menu when the user enters the firmware setup menu during the boot, process. At 526, docking option may not be supported in the firmware setup menu by firmware/embedded controller 506 when the authentication of docking station 504 is unsuccessful (e.g., when docking station 504 is not associated with the specific vendor). In this example, the docking option may not be showed in the firmware setup menu when the user enters the firmware setup menu during the boot process.

FIG. 5B is an example sequence diagram 500B for removing docking option from the firmware setup menu upon detecting a disconnection event of docking station (e.g., docking station 504 as shown in FIG. 5A). For example, similarly named elements of H. 58 may be similar in structure and/or function to elements described with respect to FIG. 5A.

At 552, docking station 504 (e.g., a USB type-C docking station) may be plugged-out of the USB port of computing device 502, for instance, by a user. At 554, removal of docking station 504 (e.g., the USB type-C docking station) may be detected by first power delivery controller 508 when docking station 504 is plugged-out of computing device 502.

At 556, a disconnection event may be sent to firmware/embedded controller 506 by first power delivery controller 508. At 558, the docking option may not be supported in the firmware setup menu by firmware/embedded controller 506 upon receiving the disconnection event, In this example, the docking option may not be showed in the firmware setup menu when the user enters the firmware setup menu during the boot process.

FIG. 5C is an example sequence diagram 500C for controlling a peripheral device on docking station 504 based on a user input received via the firmware setup menu, For example, similarly named elements of FIG. 5C may be similar in structure and/or function to elements described with respect to FIGS. 5A and 5B. Further, docking station 504 may include a microcontroller 570.

At 572, computing device 502 may be entered into the firmware set-up menu, for instance, by pressing a hot key in a keyboard during a boot process of computing device 502. At 574, a check is made by embedded controller/firmware 506 to determine whether to show the docking option in the firmware setup menu, In some examples, embedded controller/firmware 506 may save a connection status of docking station 504 when docking station 504 is plugged-in or plugged-out of computing device 502. In one example, embedded controller/firmware 506 may check the saved connection status to decide whether to show or not show the docking option in the firmware setup menu. For example, embedded controller/firmware 506 may check the device identifier of docking station 504 to decide which docking options to show in the firmware setup menu. For example, the firmware setup menu may show video graphics array (VGA), display port (DP), USB-C, USB-A, and audio options corresponding to docking station “Hook” with device identifier 0x0001, show DP, USB-A, and USB-C options corresponding to docking station “Trump” with device identifier 0x0002, and show USB-C and USB-A options corresponding to docking station “ACE” with device identifier 0x0003 as depicted in the below table:

| Docking | Device | Docking options in firm are setup |
|---|---|---|
| Station | Identifier | menu |
| Hook | 0×0001 | VGA, DP, USB-C, USB-A, Audio |
| Trump | 0×0002 | DP, USB-A, USB-C |
| ACE | 0×0003 | USB-C, USB-A |

At 576, the firmware setup menu may be showed without the docking option when embedded controller/firmware 506 determines not to show the docking option in the firmware setup menu (e.g., when docking station 504 is plugged-out).

At 578, the firmware setup menu may be showed with the docking option when embedded controller/firmware 506 determines to show the docking option in the firmware setup menu (e.g., when docking station 504 is plugged-in). At 580, a user input may be received via the firmware setup menu to control (e.g., enable, disable, or configure) peripheral devices on docking station 504.

At 582, a command corresponding to the user input may be sent to first power delivery controller 506 by embedded controller/firmware 506 to control the peripheral devices. At 584, the command may be sent to second power delivery controller 510 by first power delivery controller 508 via a vendor defined message to control the peripheral devices. First power delivery controller 508 and second power delivery controller 510 may communicate with each other via vendor defined messages.

At 586, the command may be sent to microcontroller 570 (e.g., embedded controller) in docking station 504 to control the peripheral devices. At 588, the command may be executed by microcontroller 570 to enable, disable or configure the peripheral devices on docking station 504. Microcontroller 570 can use a general-purpose input/output (GPIO) pin and/or an 12C pin to control the peripheral devices.

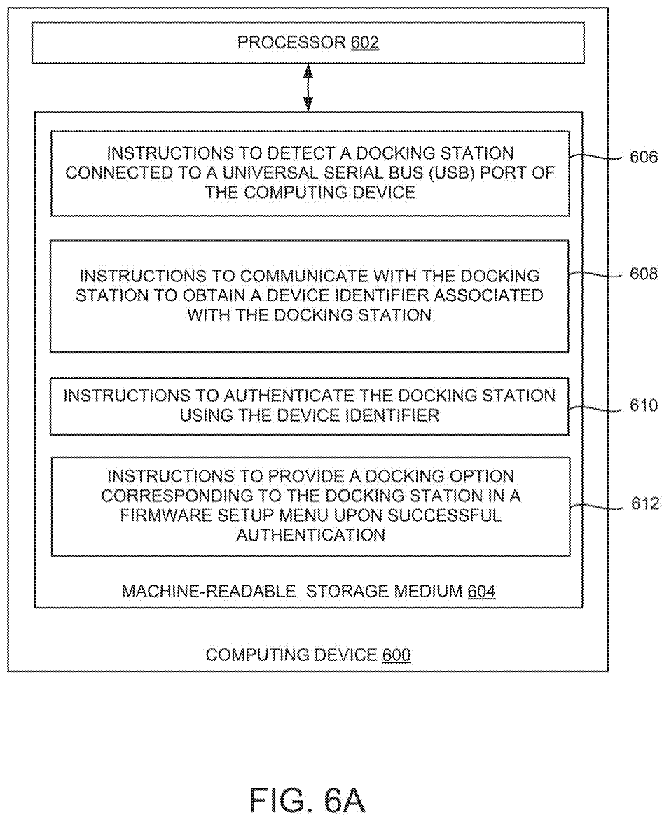

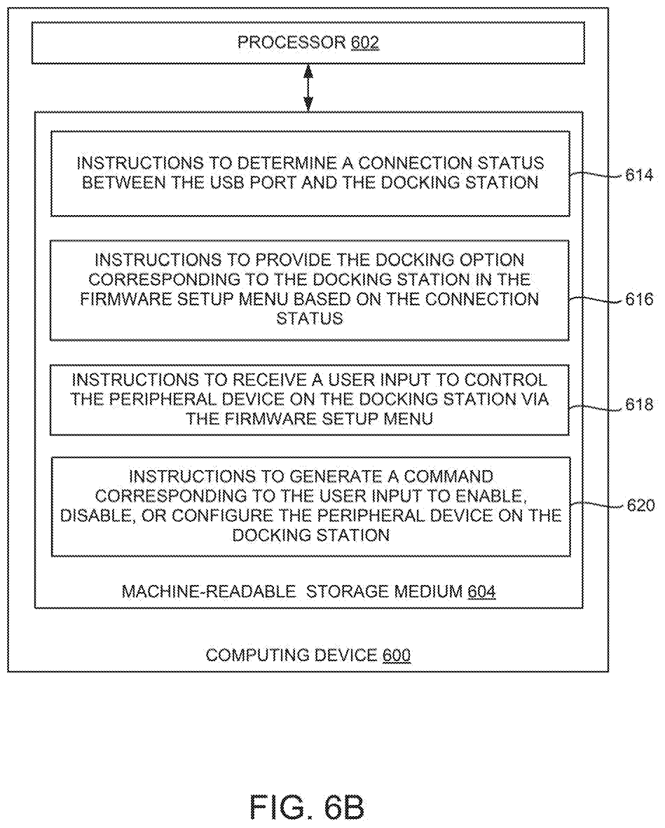

FIG. 6A is a block diagram of an example computing device 600 including a non-transitory machine-readable storage medium 604, storing instructions (e.g., 606 to 612) to provide a docking option in a firmware setup menu based on an authentication of a docking station, FIG. 6B is a block diagram of example computing device 600 of FIG. 6A, storing further instructions (e.g., 614 to 620) to enable, disable, or configure a peripheral device on the docking station based on a user input received via the firmware setup menu.

Computing device 600 may include a processor 602 and machine-readable storage medium 604 communicatively coupled through a system bus. Processor 602 may be any type of central processing unit (CPU), microprocessor, or processing logic that interprets and executes machine-readable instructions stored in machine-readable storage medium 604. Machine-readable storage medium 604 may be a random-access memory (RAM) or another type of dynamic storage device that may store information and machine-readable instructions that may be executed by processor 602. For example, machine-readable storage medium 604 may be synchronous DRAM (SDRAM), double data rate (DDR), rambus DRAM (RDRAM) rambus RAM, etc., or storage memory media such as a floppy disk, a hard disk, a CD-ROM, a DVD, a pen drive, and the like. In an example, machine-readable storage medium 604 may be a non-transitory machine-readable medium. In an example, machine-readable storage medium 604 may be remote but accessible to computing device 600.

As shown in FIG. 6A, machine-readable storage medium 604 may store instructions 606-612. In an example, instructions 606-612 may be executed by processor 602 to provide the docking option in the firmware setup menu. Instructions 606 may be executed by processor 602 to detect a docking station connected to a USB port of the computing device 600. For example, the USB port may be a USB type-C connector and the docking station may include a USB type-C plug to mate with the USB type-C connector,

Instructions 608 may be executed by processor 602 to communicate with the docking station to obtain a device identifier associated with the docking station. In one example, computing device 600 and the docking station may communicate with each other via a vendor defined message, i.e., a standard in a USB power delivery protocol. Instructions 610 may be executed by processor 602 to authenticate the docking station using the device identifier.

Instructions 612 may be executed by processor 602 to provide a docking option corresponding to the docking station in a firmware setup menu upon successful authentication. In one example, the docking option may control a peripheral device on the docking station via the firmware setup menu as shown in FIG. 6B.

As shown in FIG. 6B, machine-readable storage medium 604 may store instructions 614-620. In an example, instructions 614-620 may be executed by processor 602 to enable, disable, or configure the peripheral device on the docking station via the firmware setup menu.

Instructions 614 may be executed by processor 602 to determine a connection status between the USB port and the docking station. In some examples, the connection status may be stored in an embedded controller, Instructions 616 may be executed by processor 602 to provide the docking option corresponding to the docking station in the firmware setup menu based on the connection, status, upon entering the firmware setup menu during a boot process.

Instructions 618 may be executed by processor 602 to receive a user input to control the peripheral device on the docking station via the firmware setup menu. Instructions 620 may be executed by processor 602 to generate a command corresponding to the user input to enable, disable, or configure the peripheral device on the docking station. The command may be followed/executed by the docking station to enable, disable, or configure the peripheral device.

It may be noted that the above-described examples of the present solution are for the purpose of illustration only. Although the solution has been described in conjunction with a specific implementation thereof, numerous modifications may be possible without materially departing from the teachings and advantages of the subject matter described herein. Other substitutions, modifications and changes may be made without departing from the spirit of the present solution. All of the features disclosed in this specification (including any accompanying claims, abstract, and drawings), and/or all of the steps of any method or process so disclosed, may be combined in any combination, except combinations where at least some of such features and/or steps are mutually exclusive.

The terms “include” “have,” and variations thereof, as, used herein, have the same meaning as the term “comprise” or appropriate variation thereof. Furthermore, the term “based on”, as used herein, means “based at least, in part on.” Thus, a feature that is described as based on some stimulus can be based on the stimulus or a combination of stimuli including the stimulus.

The present description has been shown and described with reference to the foregoing examples. It is understood, however, that other forms, details, and examples can be made without departing from the spirit and scope of the present subject matter that is defined in the following claims.

What is claimed is:

1. An apparatus comprising:
a port to couple a docking station to the apparatus; and
an embedded controller to:
receive a connection status of the docking station;
provide a docking option corresponding to the docking station in a firmware setup menu based on the connection status;
receive a user input to control a peripheral device on the docking station via the docking option in the firmware setup menu; and
generate a command corresponding to the user input to control the peripheral device on the docking station.

2. The apparatus of claim 1, wherein the port is a universal serial, bus (USB) type-C connector.

3. The apparatus of claim 1, further comprising:
a first power delivery controller to:
communicate with a second power delivery controller associated with the docking station via a first vendor defined message to detect the connection status between the port and the docking station; and
send the connection status to the embedded controller,

4. The apparatus of claim 3, wherein the first power delivery controller is to:
receive the command corresponding to the user input from the embedded controller; and
communicate the command to the second power delivery controller via a second vendor defined message, wherein the peripheral device is enabled, disabled, or configured based on executing the command by a microcontroller in the docking station.

5. The apparatus of claim 1, wherein the embedded controller is to:
authenticate the docking station using a device identifier; and
provide the docking option in the firmware setup menu upon successful authentication.

6. The apparatus of claim 1, wherein the embedded controller is to:
provide the docking option corresponding to the docking station in the firmware setup menu when the docking station is connected to the port; and
remove the docking option corresponding to the docking station from the firmware setup menu when the docking station is disconnected from the port.

7. A computing device comprising:
a universal serial bus (USB) port;
a first power delivery controller to:
detect a docking station connected to the USB port; and
communicate with the docking station to obtain a device identifier associated with the docking station, and
an embedded controller to:
receive the device identifier associated with the docking station from the first power delivery controller; and
provide a docking option corresponding to the docking station in a firmware setup menu based on the device identifier, wherein the docking option is to control a peripheral device on the docking station via the firmware setup menu.

8. The computing device of claim 7, wherein the USB port is a USB type-C connector.

9. The computing device of claim 7, wherein the embedded controller is to:
authenticate the docking station using the device identifier; and
provide the docking option in the firmware setup menu upon successful authentication.

10. The computing device of claim 7, wherein the first power delivery controller is to:
communicate with a second power delivery controller in the docking station via a vendor defined message to obtain the device identifier.

11. The computing device of claim 7, wherein the embedded controller is to:
receive, via the firmware setup menu, a user input to control the peripheral device on the docking station; and
generate and send a command corresponding to the user input to the first, power delivery controller, wherein the first power delivery controller is to send the command to a second power delivery controller in the docking station via a vendor defined message to control the peripheral device on the docking station, and wherein the peripheral device is enabled, disabled, or configured by a microcontroller in the docking station based on the command.

12. The computing device of claim 7, wherein the first power delivery controller is to detect a disconnection event between the docking station and the USB port and communicate the disconnection event to the embedded controller, and wherein the embedded controller is to remove, the docking option corresponding, to the docking station from the firmware setup menu based on the disconnection event.

13. A non-transitory machine-readable storage medium encoded with instructions that, when executed by a computing device, cause the computing device to:
detect a docking station connected to a universal serial bus (USB) port of the computing device:
communicate with the docking station to obtain a device identifier associated with the docking station;
authenticate the docking station using the device identifier; and
provide a docking option corresponding to the docking station in a firmware setup menu, upon successful authentication, wherein the docking option is to control a peripheral device on the docking station via the firmware setup menu.

14. The non-transitory machine-readable storage medium of claim 13, further comprising instructions to:
determine a connection status between the USB port and the docking station;
upon entering the firmware setup menu during a boot process, provide the docking option corresponding to the docking station in the firmware setup menu based on the connection status;
receive a user input to control the peripheral device on the docking station via the firmware setup menu; and
generate a command corresponding to the user input to enable, disable, or configure the peripheral device on the docking station.

15. The non-transitory machine-readable storage medium of claim wherein the USB port is a USB type-C connector, wherein the docking station comprises a USB type-C plug to mate with the USB type-C connector, and wherein the computing device and the docking station are to communicate via a vendor defined message.
